(19) United States
(12) Patent Application Publication
(10) Pub. No.: US 2001/0032194 A1
(43) Pub. Date: Oct. 18, 2001

(54) Transaction intermediary apparatus, method and system with negotiation capability for transaction of goods or services through communication network

(76) Inventors: Toru Kutsuzawa, Tokyo (JP); Masahiro Shimomura, Tokyo (JP)

Correspondence Address: MURAMATSU & ASSOCIATES, Suite 225, 7700 Irvine Center Drive, Irvine, CA, 92618, US

(21) Appl. No.: 09/776,423

(22) Filed: Feb. 2, 2001

(30) Foreign Application Priority Data
Mar. 3, 2000 (JP) 2000-58769

(51) Int. Cl. G06F 17/60

(52) U.S. Cl. 705/80

(57) ABSTRACT

A transaction intermediary apparatus, system and method with a negotiation capability promote trade of goods or services between buyers and sellers for achieving buyer driven transactions including transactions resulted from negotiation requests initiated by buyers. The apparatus receives first and second offer data of goods or services provided by sellers where the second offer data has conditions more beneficial to buyers in price or quality than that of the first offer data. The apparatus receives purchase conditions requested by a buyer and offers, in response, the first offer data to the buyer, receives a negotiation request from the buyer, and offers the second offer data in response to the negotiation request.

### FIELD OF THE INVENTION

The present invention relates to a transaction intermediary apparatus, method and system to act as an intermediary in business transactions over a communication network, and more particularly, to a transaction intermediary apparatus, method and system using a communication network for exchanging information between buyers and sellers including dynamic negotiations, especially, buyer driven negotiations, to achieve business transaction favorable to buyers.

### BACKGROUND OF THE INVENTION

Due to the advancement of communication technologies such as Internet and world wide web (WWW), commercial transaction dealing with goods and services today is changing dramatically. The advantages of commercial transaction using the Internet is, firstly, many middlemen between buyers and sellers are no longer required. Secondary, since buyers can purchase or reserve goods and services through the communication network, physical stores to display and invite customers are unnecessary.

One manifestation of such a commercial transaction is so-called “a reverse auction method” disclosed in the U.S. Pat. No. 5,794,207, that has a style inverse to the traditional style of auction between sellers and buyers for goods or services.

More particularly, a normal auction proceeds in the following steps. First, an intermediary between the seller and the buyer announces the start of auction with a relatively low price. The buyer announces a price higher than that raised by the intermediary. Another buyer then announces a price still higher than the predecessor's price. Repeating this procedure increases the price continuously, while the number of buyers gradually decreases. Then, the intermediary sells the goods to the highest bidder. Alternatively, a seller may announce the price to invite buyers to pronounce the item to be sold without involving an intermediary. In this manner, in the normal auction, there is only one (1) seller, while there are a plurality of buyers, and accordingly, the seller has the power to determine the final deal.

On the other hand, in the “reverse-auction method” described in the U.S. Pat. No. 5,794,207, the buyer has the power to determine the price. In this method, it is presumed that a plurality of sellers exist for one (1) buyer. Thus, the buyer announces his/her desired purchase price. An intermediary (service provider) notifies the desired price to the plurality of sellers through the communication network. Each seller offers a price determined by considering the buyer's desired purchase price. The intermediary notifies the result to the buyer to complete the transaction.

In principle, the “reverse auction method” in the U.S. Pat. No. 5,794,207 is similar to a normal commercial transaction in that the buyer obtains estimates from a plurality of sellers to select a seller that can offer buyer's preference. In the reverse auction, by using the communication network, the service provider acts as an intermediary. By prompting the buyer to input the account number of a credit card or its equivalent upon entering the buyer's desired purchase price, the payment is ensured. The transaction is established when the seller agrees to sell or intermediary selects a seller from the plurality of sellers. In this regard, the U.S. Pat. No. 5,794,207 provides a new method of commercial transaction.

However, the “reverse auction method” has the following drawbacks. In this method, sellers sees the purchase conditions by a buyer such as a price and when the sellers want to sell their goods or services, the sellers send their conditions. In other words, the buyer is bound by the terms such as a price responded from the seller. Thus, if the response that matches the condition requested by the seller exists, the transaction such as purchase or reservation is automatically completed. The buyer cannot compare the conditions proposed by the plurality of sellers or select a seller that best matches the seller's preference.

In general, the demand and price for goods or services often fluctuate by various conditions such as a time, season, environmental situations and competition. For example, in using a hotel, the operation rate of the hotel is high in a sightseeing season or a long holiday season. Due to the balance between the supply and demand, hotels set the prices relatively high in such a season. On the other hand, in an off-peak season, the hotels tend to set lower prices. This is because, in the off-peak season, hotels prefer to fill the rooms with discount prices rather than leaving the rooms empty. Thus, there is a possibility for negotiation in terms of price or other conditions by customers.

The reverse auction method described in the U.S. Pat. No. 5,794,207 does not allow such a room for negotiation. Thus, this method will not lead to price drop for goods and services, or fails to promote free competition for goods and services. Despite the availability of a seller that is willing to provide a price even lower than that of the buyer initially requested, such a situation or opportunity will be lost by this method.

### SUMMARY OF THE INVENTION

In view of the foregoing, it is an object of the present invention to provide a transaction intermediary apparatus and method, and a transaction intermediary system with a negotiation capability in which a buyer is able to finalize the transaction with better purchase conditions and seller is able to increase the number of transactions, thereby promoting free competition and price slash.

It is another object of the present invention to provided a transaction intermediary apparatus and method with dynamic negotiation which is able to attract buyers of varying degrees of needs and conditions, thereby achieving buyer driven transactions.

It is a further object of the present invention to provide a transaction intermediary apparatus and method with dynamic negotiation in which a buyer is able to complete the transaction with better purchase conditions and a seller is able to increase the number of transactions, thereby promoting sellers and buyers to more frequently use the transaction system.

Reflecting upon the problems in the foregoing, one aspect of the present invention is a transaction intermediary apparatus with a negotiation capability for trading goods or services between buyers and sellers for achieving buyer driven transactions including transactions resulted from negotiation requests initiated by buyers. The transaction intermediary apparatus includes a first offer data receiving means for receiving first offer data which includes regular price data of goods or services provided by at least one seller, a second offer data receiving means for receiving at least one kind of second offer data which has conditions more beneficial to buyers in price or quality than that of the first offer data, a requested condition data receiving means for receiving conditions requested by a buyer which includes at least a price range desired by the buyer for the goods or services, a data retrieving means for retrieving data concerning goods or services which matches the conditions requested by the buyer, a first offer means for offering the data on the goods or services retrieved from the first offer data by the data retrieving means to the buyer, a negotiation request receiving means for receiving at least one negotiation request which requests a transaction condition more beneficial to the buyer in the price or quality than the data retrieved from the first offer data, a second offer means for offering at least one kind of the second offer data to the buyer in response to the negotiation request, a transaction intent receiving means for receiving a transaction intent of the buyer to agree on the transaction after offering the second offer data at least once, and a transaction intent sending means for sending the transaction intent of the buyer to the seller which at least includes a seller who provides the goods or services agreed upon by the buyer.

According to the present invention, the buyer receives an offer from the seller regarding the price and quality which are responsive to the purchase condition indicated by the buyer. Then, if the buyer requests a negotiation, the buyer receives an improved offer from the seller regarding the price and quality which are responsive to the negotiation request. The price in the purchase condition by the buyer is expressed by a price range defined by an upper limit and a lower limit. Thus, the sellers who provide the offer within the price range will be selected in the first response. Further, there will be no offer from sellers which is far outside of the purchase condition by the buyer. By selecting the most preferable offer out of the offers from the sellers, the buyer can receive the goods or service that best suited to him/her preference.

In the present invention, preferably, the transaction intermediary apparatus further includes a storage means for storing at least one of the first offer data and the second offer data. With this arrangement, at least one of the first offer data with the regular prices or the second offer with the negotiation prices can be stored in advance in the storage means in the transaction intermediary apparatus. As a consequence, when receiving the purchase condition or negotiation request from the buyer, the intermediary apparatus can retrieve information from the storage means without requesting the information from the seller and immediately send the retrieved first offer or second data to the buyer.

In the present invention, a typical example of the subject matter of the transaction through the transaction intermediary apparatus is hotel room reservation. The transaction intermediary apparatus of the present invention assists the buyer to make reservation for staying in a hotel, using facilities in the hotel, or shopping at stores in the hotel through the communication with the capability of negotiation. Accordingly, the hotels can provide services to buyers with lower price as well as improve the operating efficiency, which promotes free competition and price slash in the hotel industry.

In the present invention, preferably, the transaction intermediary apparatus further includes a handling fee setting means for setting a handling fee to be charged to at least one of the buyer or the seller depending on a level of benefit provided to the buyer by the second offer data. Thus, the buyer and seller pay the handling fee depending on the degree of negotiation. Further, a person who manages the intermediary server receives the fee depending on the degree of negotiation. Therefore, the present invention can achieve satisfactory results to the buyer, the seller and the intermediary server manager.

In the present invention, preferably, the handling fee setting means modifies the amount of the handling fee depending on at least one of parameters including types of the buyer and seller, goods or servers to be traded, and conditions of transaction. With this arrangement, the handling fees can be adjusted by various parameters such as a size of the seller, a type of goods or services, or a timing of providing the goods or services.

In the transaction intermediary apparatus of the present invention, preferably, the second offer data includes data showing a degree relative to the regular price. In other words, the second offer data is not necessarily a specific figure of price but a ratio or percentage relative to the regular price. Thus, by setting the regular price “10,000 yen” and “discount rate 20%” by a seller, the second offer to be sent to the buyer after the negotiation is defined as “8,000 yen”. Similarly, by setting the regular price “10,000 yen” and “discount price 80%” by a seller, the negotiation price of “8,000 yen” is also defined in the intermediary apparatus. Further, it is also possible to set a tariff price which is an official price higher than the regular price in the intermediary apparatus and define the regular price and the negotiation price by, for example, “discount rate 20%” or “discount rate 40%”, respectively.

According to the present invention, the negotiation request by the buyer requests goods or services more favorable to the buyer by selecting a specific price within the regular price listed in the first offer data which is within the price range initially requested by the buyer, and the second offer means provides the second offer data to the buyer in response to the negotiation request. With this arrangement, the buyer can receive offers of better goods or services from sellers with the price equivalent to the specific price defined by the buyer. For example, suppose the buyer specifies a price of “10,000 yen” when the requested price range is “between 8,000 yen and 10,000 yen”. Then the offers from the sellers will be the goods or services of about 10,000 yen listed in the negotiation price database. Thus, the buyer can obtain goods or services more favorable to him/her than that originally available by 10,000 yen.

In the present invention, preferably, the negotiation request by the buyer requests goods or servers more favorable to the buyer by specifying a seller and a good or service by the specified seller which is more favorable to the buyer, and the second offer means provides the second offer data to the buyer in response to the negotiation request. With this arrangement, the buyer can receive offers of better goods or services from the seller specified by the buyer. For example, suppose the buyer specifies a good or service whose price is “10,000 yen” when the requested price range is “between 8,000 yen and 10,000 yen”. Then the offers from the specified seller will be the goods or services of about 10,000 yen listed in the negotiation price database. Thus, the buyer can obtain goods or services more favorable to him/her than that originally available by 10,000 yen through the specified seller.

Preferably, the transaction intermediary apparatus of the present invention further includes a character control means for controlling an operation of a character who negotiates with the sellers for the buyer, and a display means for displaying the character. The character control means operates, in response to requests by the buyer, to attain the second offer data more favorable to the buyer, thereby achieving a final transaction of goods or services which matches with the negotiation request by the buyer. With this arrangement, the buyer can enjoy a game while pursuing the negotiation procedure. Further, the buyer may not feel that he/she is demanding discount and eventually attain the transaction with favorable terms.

In the present invention, preferably, the transaction intermediary apparatus further includes a payment processing means which performs a payment procedure for a transaction completed between the buyer and seller at the same time or after sending the transaction intent of the buyer to the seller. With this arrangement, an overall procedure of transaction including the payment can be done by the transaction intermediary apparatus. The seller can securely receive payment from the buyer, and also, the intermediary server can receive the handling fee.

Another aspect of the present invention is a transaction intermediary apparatus for trading goods or services between buyers and sellers. The transaction intermediary apparatus includes a seller input terminal for inputting first offer data which includes regular price data of goods or services and second offer data which has conditions more favorable to buyers in price or quality than that shown in the first offer data, a buyer input terminal for inputting purchase conditions requested by a buyer which includes a price range for the goods or services, and an intermediary server provided between the seller input terminal and the buyer input terminal for assisting the buyer who request a negotiation to attain conditions more beneficial to buyers in price or quality.

Upon receiving the first offer data and the second offer data, the seller input terminal sends the first offer data and the second offer data to the intermediary server, and receives a transaction intent from the buyer. The buyer input terminal is able to input the purchase conditions by the buyer, the negotiation request, the transaction intent, and receives the first offer data and the second offer data from the sellers through the intermediary server.

The intermediary server retrieves first offer data to seek goods or services which matches the purchase conditions requested by the buyer, sends the retrieved results to the buyer, receives at least one negotiation request and retrieves the second offer data to seek goods or services which matches the negotiation request by the buyer, sends the retrieved results to the buyer, receives the transaction intent of the buyer, and sends the transaction intent to the seller who provides the goods or services agreed upon by the buyer.

According to the present invention, the buyer receives an offer from the seller regarding the price and quality which are responsive to the purchase condition indicated by the buyer. Then, if the buyer requests a negotiation, the buyer receives an improved offer from the seller regarding the price and quality which are responsive to the negotiation request. The price in the purchase condition by the buyer is expressed by a price range defined by an upper limit and a lower limit. Thus, the sellers who provide the offer within the price range will be selected in the first response. Further, there will be no offer from sellers which is far outside of the purchase condition by the buyer. By selecting the most preferable offer out of the offers from the sellers, the buyer can receive the goods or service that best suited to him/her.

In the present invention, preferably, the transaction intermediary apparatus further includes a storage means for storing at least one of the first offer data and the second offer data. With this arrangement, at least one of the first offer data with the regular prices or the second offer with the negotiation prices can be stored in advance in the storage means in the transaction intermediary apparatus. As a consequence, when receiving the purchase condition or negotiation request from the buyer, the intermediary apparatus can retrieve information from the storage means without requesting the information from the seller and immediately send the retrieved first offer or second data to the buyer.

In the present invention, a typical example of the subject matter of the transaction through the transaction intermediary apparatus is hotel room reservation. The transaction intermediary apparatus of the present invention assists the buyer to make reservation for staying in a hotel, using facilities in the hotel, or shopping at stores in the hotel through the communication with the capability of negotiation. Accordingly, the hotels can provide services to buyers with lower price as well as improve the operating efficiency, which promotes free competition and price slash in the hotel industry.

In the present invention, preferably, the transaction intermediary apparatus further includes a handling fee setting means for setting a handling fee to be charged to at least one of the buyer or the seller depending on a level of benefit provided to the buyer by the second offer data. Thus, the buyer and seller pay the handling fee depending on the degree of negotiation. Further, a person who manages the intermediary server receives the fee depending on the degree of negotiation. Therefore, the present invention can achieve satisfactory results to the buyer, the seller and the intermediary server manager.

In the present invention, preferably, the handling fee setting means modifies the amount of the handling fee depending on at least one of parameters including types of the buyer and seller, goods or servers to be traded, and conditions of transaction. With this arrangement, the handling fees can be adjusted by various parameters such as a size of the seller, a type of goods or services, or a timing of providing the goods or services.

In the transaction intermediary apparatus of the present invention, preferably, the second offer data includes data showing a degree relative to the regular price. In other words, the second offer data is not necessarily a specific figure of price but a ratio or percentage relative to the regular price. Thus, by setting the regular price “10,000 yen” and “discount rate 20%” by a seller, the second offer to be sent to the buyer after the negotiation is defined as “8,000 yen”. Similarly, by setting the regular price “10,000 yen” and “discount price 80%” by a seller, the negotiation price of “8,000 yen” is also defined in the intermediary apparatus. Further, it is also possible to set a tariff price which is an official price higher than the regular price in the intermediary apparatus and define the regular price and the negotiation price by, for example, “discount rate 20%” or “discount rate 40%”, respectively.

According to the present invention, the negotiation request by the buyer requests goods or servers more favorable to the buyer by selecting a specific price within the regular price listed in the first offer data which is within the price range initially requested by the buyer, and the second offer means provides the second offer data to the buyer in response to the negotiation request. With this arrangement, the buyer can receive offers of better goods or services from sellers with the price equivalent to the specific price defined by the buyer. For example, suppose the buyer specifies a price of “10,000 yen” when the requested price range is “between 8,000 yen and 10,000 yen”. Then the offers from the sellers will be the goods or services of about 10,000 yen listed in the negotiation price database. Thus, the buyer can obtain goods or services more favorable to him/her than that originally available by 10,000 yen.

In the present invention, preferably, the negotiation request by the buyer requests goods or servers more favorable to the buyer by specifying a seller and a good or service by the specified seller which is more favorable to the buyer, and the second offer means provides the second offer data to the buyer in response to the negotiation request. With this arrangement, the buyer can receive offers of better goods or services from the seller specified by the buyer. For example, suppose the buyer specifies a good or service whose price is “10,000 yen” when the requested price range is “between 8,000 yen and 10,000 yen”. Then the offers from the specified sellers will be the goods or services of about 10,000 yen listed in the negotiation price database. Thus, the buyer can obtain goods or services more favorable to him/her than that originally available by 10,000 yen through the specified seller.

Preferably, the transaction intermediary apparatus of the present invention further includes a character control means for controlling an operation of a character who negotiates with the sellers for the buyer, and a display means for displaying the character. The character control means operates, in response to requests by the buyer, to attain the second offer data more favorable to the buyer, thereby achieving a final transaction of goods or services which matches with the negotiation request by the buyer. With this arrangement, the buyer can enjoy a game while pursuing the negotiation procedure. Further, the buyer may not have a feeling that he/she is demanding discount and eventually attain the transaction with favorable terms.

In the present invention, preferably, the transaction intermediary apparatus further includes a payment processing means which performs a payment procedure for a transaction completed between the buyer and seller at the same time or after sending the transaction intent of the buyer to the seller. With this arrangement, an overall procedure of transaction including the payment can be done by the transaction intermediary apparatus. The seller can securely receive payment from the buyer, and also, the intermediary server can receive the handling fee.

In the present invention, the intermediary server system promotes the transaction between the buy and seller by forming an intermediary transaction system accessible through a home page on the Internet. With this arrangement, a manager or an owner of the intermediary server establishes his/her home page and loads the same in a server computer to automatically function as an intermediary server. Buyers or sellers need not to have dedicated communication lines and can proceed the transaction by simply connecting the personal computers or terminals to the Internet. Thus, the present invention can achieve a low cost and convenient transaction system for both buyers and sellers.

Preferably, in the transaction intermediary apparatus of the present invention, at least one of the seller input terminal or the buyer input terminal is a wireless telephone, and the intermediary server promoting the transaction between the buyer and the sellers when receiving the data through the wireless telephone. With this arrangement, sellers and buyers can access the intermediary server through wireless phones. This is convenient, especially when the transaction can be done only between the buyer and the intermediary server, because the buyer can proceed the transaction while he/she is out of the office.

A further aspect of the present invention is a transaction intermediary method involving a negotiation capability for trading goods or services between buyers and sellers for achieving buyer driven transactions including transactions resulted from negotiation requests initiated by buyers. The transaction intermediary method includes the steps of a first offer data receiving step for receiving first offer data which includes regular price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data through the data retrieving step to the buyer, a negotiation request receiving step for receiving at least one negotiation request which requests a transaction condition more beneficial to the buyer in the price or quality than the data retrieved from the first offer data, a second offer step for offering at least one kind of the second offer data to the buyer in response to the negotiation request, a transaction intent receiving step for receiving a transaction intent of the buyer to agree on the transaction after offering the second offer data at least once, and a transaction intent sending step for sending the transaction intent of the buyer to the seller which includes at least a seller who provides the goods or services agreed upon by the buyer.

According to the present invention, the buyer receives an offer from the seller regarding the price and quality which are responsive to the purchase condition indicated by the buyer. Then, if the buyer requests a negotiation, the buyer receives an improved offer from the seller regarding the price and quality which are responsive to the negotiation request. The price in the purchase condition by the buyer is expressed by a price range defined by an upper limit and a lower limit. Thus, the sellers who provide the offer within the price range will be selected in the first response. Further, there will be no offer from sellers which is far outside of the purchase condition by the buyer. By selecting the most preferable offer out of the offers from the sellers, the buyer can receive the goods or service that best suited to him/her.

In the present invention, the subject matter of the transaction through the transaction intermediary method is hotel room reservation. The transaction intermediary method of the present invention assists the buyer to make reservation for staying in a hotel, using facilities in the hotel, or shopping at stores in the hotel through the communication with the capability of negotiation. Accordingly, the hotels can provide services to buyers with lower price as well as improve the operating efficiency, which promotes free competition and price slash in the hotel industry.

### BRIEF DESCRIPTION OF THE DRAWINGS

FIG. 1 is a block diagram showing an example of network system including the transaction intermediary apparatus of the present invention having a negotiation capability.

FIG. 2 is a block diagram showing an image of hotel room reservation process as one of applications of the transaction intermediary method of the present invention.

FIG. 3 is a block diagram showing an example of structure of an intermediary server in the transaction intermediary system of the present invention.

FIG. 4 is a diagram displayed on the customer terminal and intermediary server showing an image of a negotiator character who is negotiating with hotels in the hotel room reservation process by the transaction intermediary apparatus of the present invention.

FIG. 5 is a flow chart showing an example of hotel room reservation process by the transaction intermediary apparatus of the present invention for offering one kind of negotiation prices by the hotels.

FIG. 6 is a flow chart showing an example of hotel room reservation process by the transaction intermediary apparatus of the present invention for offering three kinds of negotiation prices by the hotels.

FIG. 7 is a flow chart showing an example of hotel room reservation process by the transaction intermediary apparatus of the present invention following the process of FIG. 6.

FIG. 8 is a chart showing an example of relationship among price ranges including regular price and discount prices upon degrees of negotiation, discount rates, and fees charged to buyers and sellers in the hotel room reservation process by the transaction intermediary apparatus of the present invention.

FIG. 9 is a flow chart showing an example of negotiation process assisted by the transaction intermediary apparatus of the present invention.

FIG. 10 is a flow chart showing an example of negotiation process following the process of FIG. 9 in the present invention.

FIG. 11 is a flow chart showing another example of negotiation process assisted by the transaction intermediary apparatus of the present invention.

FIG. 12 is a flow chart showing an example of negotiation process following the process of FIG. 11 in the present invention.

### DETAILED DESCRIPTION OF THE PREFERRED EMBODIMENTS

The embodiments of the transaction intermediary apparatus, method and system of the present invention will be described hereafter with reference to the accompanying drawings. Hereafter, the present invention is described for the case in which the subject matter of the transaction is hotel reservation only for an illustration purpose. Thus, the present invention is not limited to that particular application, but can be applicable to transactions of other services or goods.

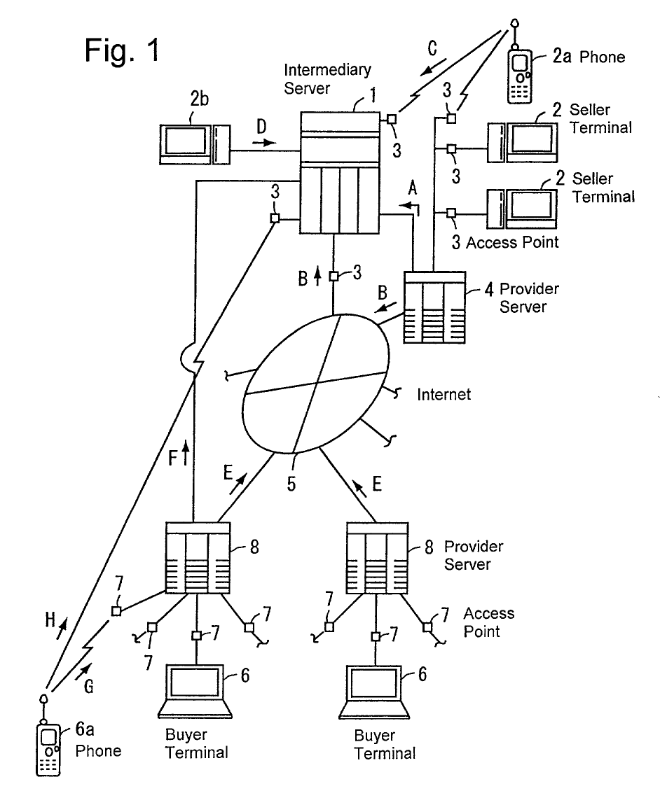

FIG. 1 shows an example of network system including the transaction intermediary apparatus of the present invention having a negotiation function. The transaction intermediary apparatus 1 (Hereafter may also be referred to as “intermediary server 1”) is a computer system that receives various kinds of data from sellers and sends the seller's offer data to buyers through the communication network in response to the requests made by the buyers. The sellers send the offer data through seller data terminals 2 or wireless telephones (cellular phones) 2a. The buyers send the initial request or negotiation request from buyer terminals 6 or wireless telephones (cellular phone) 6a. FIG. 1 also shows a communication network such as Internet 5 and Internet provider servers 4 and 8. Numerals 3 and 7 denote access points in the communication network.

The intermediary server 1 receives first offer data from the seller data terminal 2 (hereafter may also be referred to as “hotel terminal 2”) which is directed to hotel room information for hotel room reservation purposes. The first offer data includes information on regular prices of the rooms, grades of the rooms, and types (single or twin, etc) of the rooms. The intermediary server 1 also receives second offer data from the hotel terminal 2 produced by the seller in response to the terms and conditions in the negotiation requested by the buyer.

In this example, the second offer data includes hotel room information which is more favorable to the buyer, for example, a price (“negotiation price” or “nego-price”) of the room which is less expensive than that shown in the first offer data. Therefore, the hotel can send not only the first offer data establishing a regular price, but also the second offer data with a negotiation price to the intermediary server 1. However, the hotels (sellers) do not have to negotiate on all of the terms and conditions in the first offer data. Depending on the type of the room, the grade of the room, etc., the seller only needs to send second offer data for the terms and conditions that can be negotiated based on seller's judgement.

The hotel room information from the hotel terminals 2 is sent to the provider servers 4 established by the Internet provider through the access points 3. Then, the hotel room information is directly sent to the intermediary server 1 (arrow A) from the provider server 4. The hotel room information can also be sent from the provider server 4 to the intermediary server 1 thorough the Internet 5 (arrow B).

As noted above, the seller data terminal 2 may be the wireless (cellular) phone 2a in addition to the hotel terminal 2. In such a case, the hotel room information is sent to the provider server 4 from the cellular phone 2a through the access point 3. The information transmitted from the cellular phone 2a to the provider server 4 can be transmitted either directly to the intermediary server 1 (arrow A) or though the Internet (arrow B). Moreover, the hotel room information can be directly transmitted to the intermediary server 1 (arrow C) without passing through the provider server 4. Accordingly, a person of a hotel in charge of this transaction apparatus can input and transmit the hotel room information while being away from his/her office. The seller data terminal 2 can be a dedicated terminal 2s that is connected to a dedicated line to the intermediary server 1. In such an arrangement, the hotel room information is transmitted to the intermediary server 1 (arrow D) without going through other facilities such as the provider server 4.

A customer (buyer) inputs data including desired conditions for hotel room reservation from the customer data terminal 6 (hereafter may also be referred to as “customer terminal 6”). More particularly, the customer's data regarding the purchase conditions (“customer purchase condition”) may include a location of hotel, a type of room and a price. The customer purchase condition is then transmitted to each provider server 8 through the access point 7. The customer purchase condition is sent to the intermediary server 1 through the Internet 5 (arrow E). The customer purchase condition can be transmitted directly to the intermediary server 1 from the provider server 8 without passing through the Internet 5 (arrow F).

The customer terminal 6 may be the wireless (cellular) phone 6a in addition to the customer terminal. In such a case, the customer purchase condition is sent to the provider server 8 from the cellular phone 6a through the access point 7. The data transmitted from the cellular phone 6a to the provider server 8 can be transmitted either directly to the intermediary server 1 (arrow F) or though the Internet (arrow E). Moreover, the customer purchase condition can be directly transmitted to the intermediary server 1 (arrow H) without involving the provider server 8. Accordingly, the customer (buyer) of this transaction system can input and transmit the purchase conditions while being away from his/her home or office.

As described in the foregoing, the hotel and the customer can transmit data to the intermediary server 1 or receive the other party's data through several routes. When such transmission is made through the Internet 5, the customer can make reservation for a hotel room by connecting his/her computer to the Internet 5. The hotel can offer or accept reservation order by connecting its computer to the Internet 5. Thus, the transaction intermediary system of the present invention is preferably implemented with the Internet for creating an easy and convenient system.

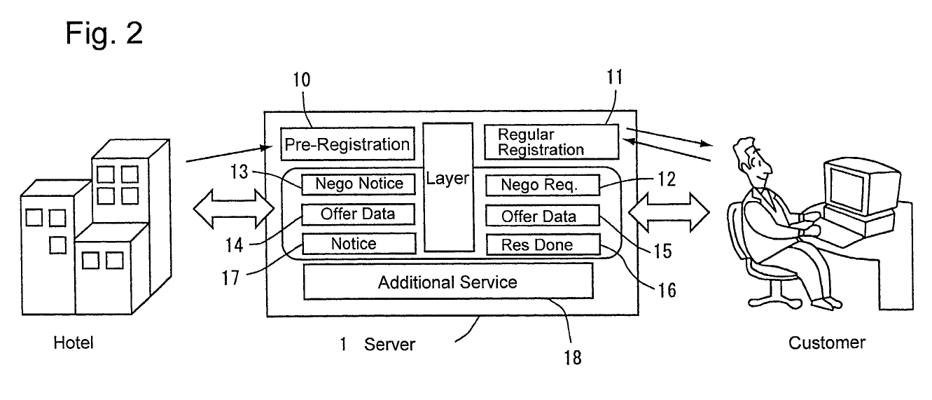

FIG. 2 is a diagram showing an example of hotel room reservation system based on the transaction intermediary apparatus of the present invention. As shown in this drawing, hotels resister their hotel information and offer data based on regular prices in the intermediary server 1. A customer accesses the intermediary server 1 and proceeds on making reservation through a regular reservation process which is based on the offer data using the regular prices. If the customer can find a hotel room which matches his/her purchase condition, the hotel room reservation will be completed under the regular reservation process.

If the customer cannot find a hotel room which matches his/her preference, the customer may go into a negotiation process. In the negotiation process, the intermediary server 1 sends a negotiation request from the customer to the sellers. Upon receiving the negotiation request, the sellers may respond to the negotiation request by sending second offer data to the intermediary server 1 while considering the season, vacancy of hotel rooms, and possible responses by competitor hotels. The intermediary server 1 sends the second offer data to the customer.

In viewing the second offer data, if the customer finds a hotel room which matches his/her purchase condition, the customer sends a transaction intent to the intermediary server 1. The transaction intent is a manifestation by the customer to agree on the terms and conditions and thus to complete the transaction. The intermediary server 1 sends the transaction intent from the customer as a notice of hotel room reservation to the hotel. In the case where the customer wants additional services such as an appointment of an interpreter or a companion, the customer sends such an additional service request to the intermediary server 1. The intermediary server 1 transfers the additional service request to the hotel.

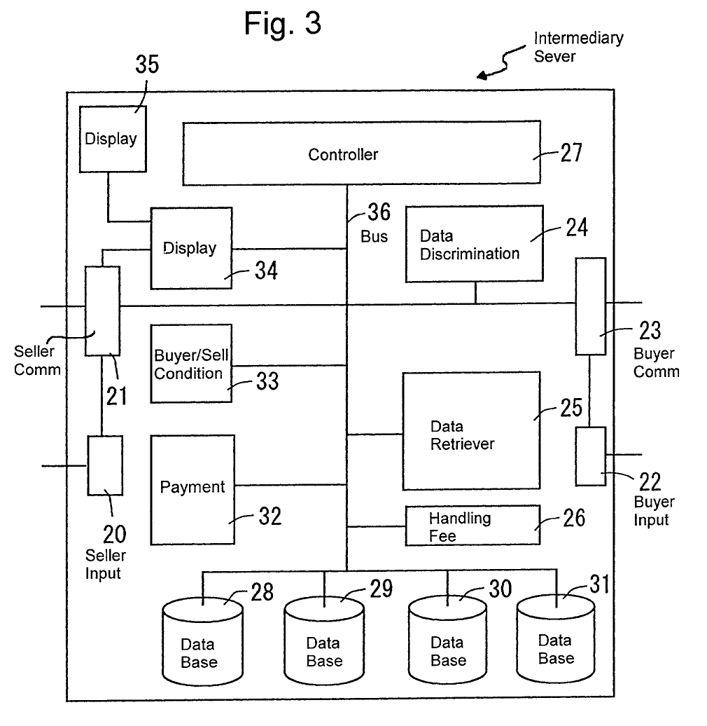

An example of configuration in the intermediary server 1 of the present invention is shown in the block diagram of FIG. 3. The intermediary server 1 includes a seller input area 20, a seller communication section 21, a buyer input area 22, a buyer communication section 23, a data discriminator 24, a data retriever 25, an intermediary handling fee unit 26, a control unit 27, a regular price database 28, and negotiation price database 29, 30 and 31, a payment processing unit 32, a buy/sell condition processor 33, a display processor 34, a display 35, and a bus 36.

The seller input area 20 is an area which receives the hotel room information from the hotel (seller). The seller input area 20 stores the hotel information which is input in the intermediary server 1 by a responsible hotel personnel or a sever manager who is instructed by the hotel employee over a telephone or facsimile. The seller communication section 21 receives data from the seller through the communication network. The seller communication section 21 functions as a first offer data receiving means and a second offer data receiving means for receiving offer data from the hotel as well as a negotiation condition transmission means for sending the negotiation terms to the hotel. The data received by the seller input area 20 is also transmitted to the seller communication section 21.

The buyer input area 22 is an area which receives the customer purchase condition data (requested hotel reservation condition) from the buyer. The buyer input area 22 stores the requested hotel reservation condition directly input in the intermediary server 1 by the buyer or a sever manager who is instructed by the buyer over a telephone or facsimile. The buyer communication section 23 receives the data from the buyer through the communication network. The buyer communication section 23 functions as a purchase condition receiving means, a negotiation request receiving means, a transaction intent receiving means, and a negotiator character selection means when receiving data from the buyer. The data received by the buyer input area 22 is also transmitted to the buyer communication section 23.

The data discriminator 24 determines whether the input data from the customer concerns either the desired purchase condition, a negotiation request, an intention to complete the transaction (transaction intent), or the end of the transaction. The data discriminator 24 performs this decision making function under the control of the controller 27 which will be described later. The data retriever 25, after receiving the desired purchase condition data from the customer, checks the first offer data given by the hotel in the regular price database 28 to see if there is data that matches the requested purchase condition. If necessary, the data retriever 25 also checks the second offer data in the negotiation price database 29, 30 or 31 to see if there is data that matches the purchase conditions requested in the negotiation from the customer, the details of which will be described later.

The intermediary handling fee unit 26 is to set handling fees to be charged to the hotel (seller) and the customer (buyer) depending on the contents of transaction. More particularly, different intermediary handling fees will be established when the hotel reservation is completed, for example, whether in the regular price or in the negotiated price. In addition, in the negotiation price, the amount of handling fees may vary based on the level of negotiation, the details of which will be explained later.

The controller 27 controls an overall operational procedure of the intermediary server 1. The controller 27 also works as a negotiation displaying and processing means that controls and displays the activities of a negotiator character. The regular price database 28 stores the hotel room information including the regular price that is pre-registered by the hotel. More specifically, the data in the database 28 shows information such as grades of the rooms, types of the rooms, visual images of the rooms, the prices of the rooms, various facilities (restaurants, clubs, shops, exercise room, etc.) in the hotel and associated charges.

The negotiation price database 29 stores the hotel room information including the negotiation price with a first predetermined negotiation rate that is pre-transmitted by the hotel. The negotiation price database 30 stores the hotel room information including the negotiation price with a second negotiation rate that is predetermined by the hotel. The second negotiation rate or discount rate is higher than the first negotiation rate. Similarly, the negotiation price database 31 stores the hotel room information including the negotiation price with a third negotiation rate that is predetermined by the hotel. The third negotiation rate or discount rate is higher than the second negotiation rate.

The information on the same room in the same hotel may be stored in the database 28, 29, 30, and 31. However, the contents of the information, typically, their prices vary among the database. Moreover, hotel room data of almost identical price is also stored in each database 28, 29, 30, 31. For example, in the regular price database 28, a single room with the price of 10,000 yen per night may be stored, while in the negotiation price database 29, a deluxe room with the price of 10,000 yen per night may be stored.

The payment processing unit 32 performs a payment procedure such as by a credit card. It also includes a payment procedure to pay a fee to the manager of the intermediary server 1 by the customer or the hotel for intermediary handling charge when such a manager assists the transaction. The payment processing unit 32 performs the payment procedure based on the customer and hotel information such as the credit card numbers.

The buy/sell condition processor 33 functions as a first offer data providing means or a second offer data providing means which converts the data searched by the data retriever 25 into a predetermined format and provides the offer data to the customer. The buy/sell condition processor 33 adds information whether negotiation is possible to the hotel room information that matches the customer purchase condition data, or arranges the hotel room information that matches the negotiation request in the order of the price or the place of lodging. When providing the offer data, the buy/sell condition processor 33 can also add a display pointer in the offer data for enabling the customer to select whether other rooms in the same hotel or the rooms with the identical grade in other hotels should be searched.

The buy/sell condition processor 33 also functions as a transaction intent transmission means that transmits the transaction intention of the customer (buyer) to complete the transaction to the hotel (seller). Further, the buy/sell condition processor 33 transmits the customer information such as the credit card number upon receiving the transaction intent by the customer.

The display processor 34 functions as a negotiator character displaying and processing means that displays a negotiator character on the customer terminal 6. Thus, the display processor 34 performs a graphic display processor for producing animations of the negotiator character. As noted above, a plurality of different negotiation levels are available in the transaction intermediary system of the present invention. The display processor 34 also functions as a transaction confirmation displaying and processing means that displays the contents of the transaction, i.e., the details of the hotel room reservation in the above example, to the customer upon receiving the transaction intent by the customer.

The display 35 is a monitor having, for example, a liquid crystal display (LCD) or a cathode ray tube (CRT). Normally, the negotiator character is displayed on the customer terminal 6 which is remote from the intermediary server 1. However, there may be a case where the customer comes to an office where the intermediary server 1 locates to make a hotel room reservation. Hence, a monitor for such a customer is also provided to the intermediary server 1 so that the customer can enjoy the activities of the negotiator character. The bus 36 is an interface bus and circuit to connect each components in the intermediary server 1. Thus, in the intermediary server 1, the data and control and processing signals are communicated through the bus 36.

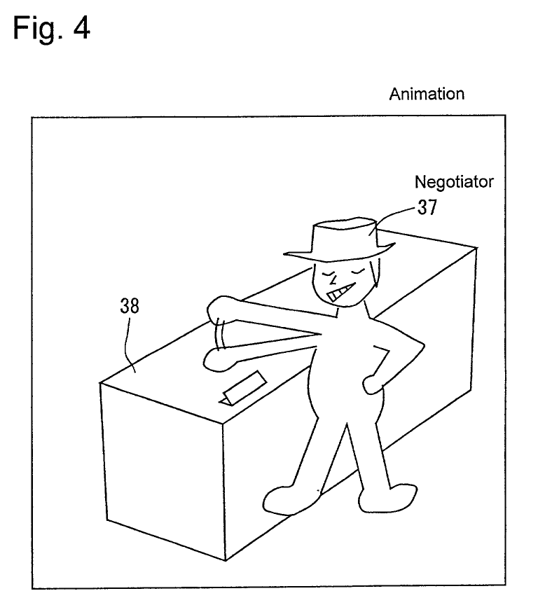

As noted above, an animation of the negotiator character will be displayed on the customer terminal and intermediary server under the control of the display processor 34. FIG. 4 shows an image of the negotiator character who is negotiating with hotels in the hotel room reservation process. A negotiator character 37 in FIG. 4 is knocking the front desk saying, for example, “I am a tough negotiator to knock the price down for my client”, and negotiating with the hotels. The customer can enjoy such an animation while pursuing the negotiation with the hotels. The animation is controlled by the controller 27 in FIG. 3 based on a computer program. A data storage medium stores such programs for controlling the negotiator character 37 and its display on a computer monitor.

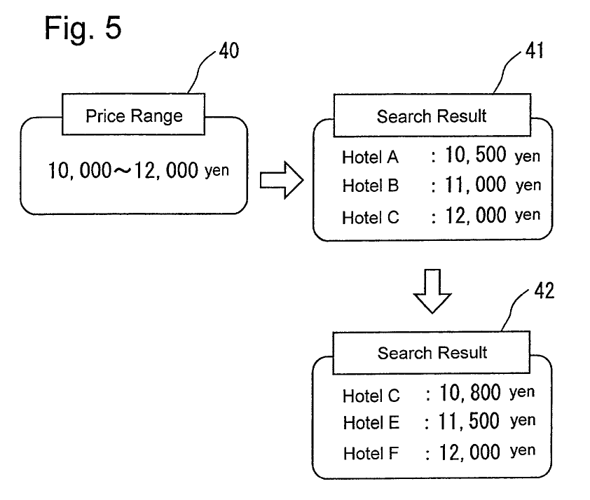

FIG. 5 shows an example of offer data with regular prices and negotiation prices by the hotels. Here, for simplicity of explanation, it is assumed that the purchase condition by the customer is only a price range. In an input screen 40, the customer inputs his price range “10,000-12,000 yen”. The data retriever 25 in the intermediary server 1 retrieves hotel room information which matches the requested price range from the regular price database 28 and display the result on a search result screen 41. In this example, the search result screen 41 lists the offer data by hotels C, D and E with their regular prices.

When the customer dissatisfied with the search results, he/she may request negotiation. The intermediary server 1 sends the negotiation request by the customer to many hotels including hotels C, D and E. Thus, hotels which would like to respond to the negotiation request send the hotel room information which matches the price range indicated by the customer. It is also possible to make such responses by the hotels by retrieving the second offer data with the negotiation price pre-registered in the database of the intermediary server 1.

A secondary search result screen 42 is displayed in response to the negotiation request by the customer. The search result screen 42 shows a list of hotel room information with negotiation prices. The offer data from hotel C decreases its price by 1,200 yen. In this example, hotel A and hotel B send the negotiation prices which are not shown in the search result screen 42 because the prices are lower than the requested price range. Alternatively, the intermediary server 1 may be arranged to display all of the offer data showing negotiation prices which are lower than the requested upper limit of 12,000 yen including the data which is lower than the lower limit 10,000 yen.

The secondary search result screen 42 includes hotel E and hotel F which were not shown in the search result screen 41 because the prices are higher than the upper limit of 12,000 yen of the requested price range. Since hotels E and F have offered the negotiation prices which are lower than the upper limit 12,000 yen, their hotel room information is now listed on the search result screen. Therefore, the customer can select his favorite hotel room through this process.

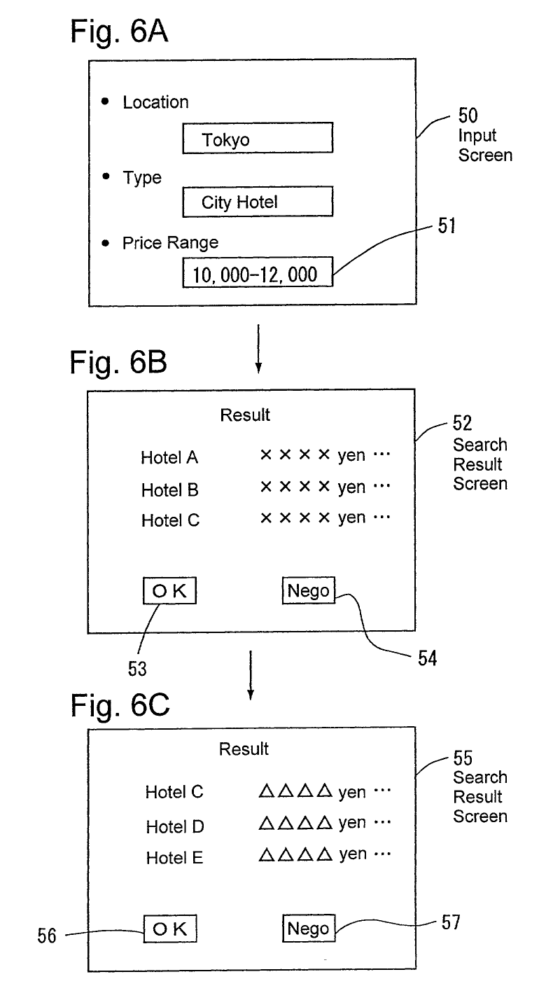

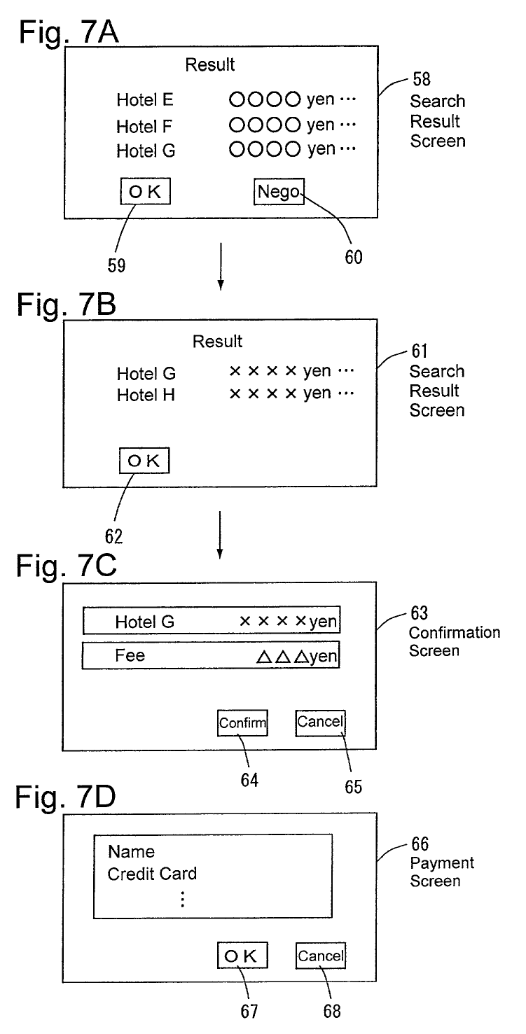

The foregoing process shown in FIG. 5 is directed to the case where only one negotiation step is involved. FIGS. 6A-6C and FIGS. 7A-7D show an example where the intermediary server 1 provides two or more negotiation steps based on customer's request.

The customer input his/her purchase condition through an input screen 50 of FIG. 6A including a location, a type of hotel and a price range. Here, it is assumed that the customer inputs the requested price range of “10,000-12,000 yen” in a price range box 51. The data retriever 25 of the intermediary server 1 searches for the hotel that matches the desired price range from the regular price database 28, and displays the result on a search result screen 52 of FIG. 6B. As a result, on the search result screen 52, hotels A, B, and C are shown with their regular prices of the hotel rooms. If the customer finds a favorite hotel room, he/she presses an OK button 53. On the other hand, if the customer is not satisfied with the search result, he/she can negotiate by pressing a negotiation (Nego) button 54 in FIG. 6B.

When the customer presses the negotiation (Nego) button 54, the intermediary server 1 retrieves the data in the negotiation price database 29 and displays the result on a second search result screen 55 in FIG. 6C. If the customer finds a favorite hotel room in the offer list shown in the search result screen 55, he/she presses an OK button 56. On the other hand, if the customer is not satisfied with the search result, he/she can further negotiate by pressing a negotiation (Nego) button 57 in FIG. 6C.

When the customer presses the negotiation (Nego) button 57, the intermediary server 1 retrieves the data in the negotiation price database 30 and displays the result on a third search result screen 58 in FIG. 7A. If the customer finds a favorite hotel room in the offer list shown in the search result screen 58, he/she presses an OK button 59. On the other hand, if the customer is not satisfied with the search result, he/she can further negotiate by pressing a negotiation (Nego) button 60 in FIG. 7A.

When the customer presses the negotiation (Nego) button 56, the intermediary server 1 retrieves the data in the negotiation price database 31 and displays the result on a third search result screen 61 in FIG. 7B. If the customer finds a favorite hotel room in the offer list shown in the search result screen 61, he/she presses an OK button 62. On the other hand, if the customer is not satisfied with the search result, he/she may go back to the previous screens 58, 55, 52 or input new purchase condition, since no further negotiation is available in the transaction system.

By pressing the OK button in the negotiation result screens of FIGS. 6B, 6C, 7A or 7B, the customer terminal 6 displays a confirmation screen 63 as shown in FIG. 7C. In this example, the confirmation screen 63 includes a hotel information section which shows the selected hotel (here, hotel G) and the price (room charge), and a server handling fee. After reading the information on the hotel G, the customer presses a confirmation button 64, which results in a payment screen 66 such as shown in FIG. 7D. If the customer decides not to make reservation, he/she may cancel the procedure by pressing a cancel button 65.

The payment screen 66 in FIG. 7D includes a section for providing the name of the customer and a credit card information for confirming the payment through the credit card. At the end of this procedure, the customer presses an OK button 67. If the customer wants to cancel this payment procedure, he/she can do so by pressing a cancel button 68.

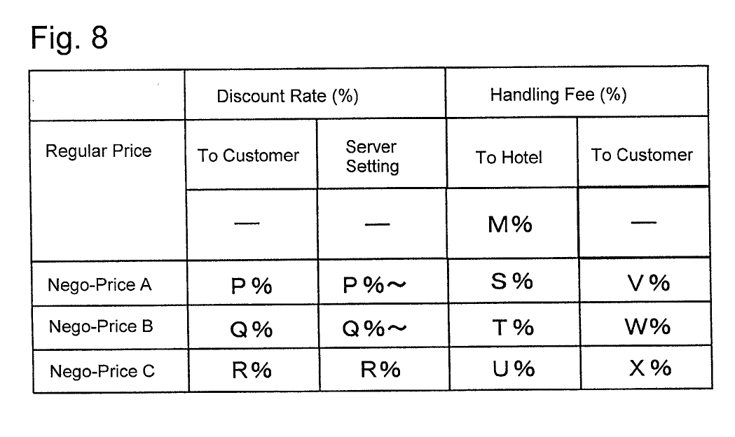

FIG. 8 is a table showing discount rate (%) relative to the regular price and negotiation price and the system handling fee (%) to the customer (buyer) and the hotel (seller). In this example, the negotiation price is classified into three (3) levels A-C. There is no discount for the regular price. Thus, when the transaction is completed for the regular price, the intermediary server 1 receives only the handling fee from the hotel (M % of the regular price).

When the transaction is completed with the negotiation price A, the final price becomes P % less than the regular price. In order to guarantee the discount rate P % for the customer, the discount rate of more than P % can be established based on several conditions. In the negotiation completed by the negotiation price A, the intermediary handling fee to the hotel is S % of the negotiation price A while the intermediary handling fee to the customer is V % of the negotiation price A.

The negotiation price B has a higher negotiation rate than that of the negotiation price A. The negotiation price B is the final price which is lower than the regular price by the discount rate Q %. In order to guarantee the discount rate Q % for the customer, the discount rate more than Q % can be established based on several conditions. Thus, when the negotiation is completed by the negotiation price B, the intermediary handling fee to the hotel is T % of the negotiation price B while the handling fee to the customer is W % of the negotiation price B.

The negotiation price C has a discount rate higher than that of the negotiation price B. The negotiation price C is the final price which is lower than the regular price by the discount rate R %. In order to guarantee the discount rate R % for the customer, the discount rate more than R % can be established based on several conditions. Thus, when the negotiation is completed by the negotiation price C, the intermediary handling fee to the hotel is U % of the negotiation price C. The intermediary handling fee to the customer is X % of the negotiation price C. The intermediary handling fees M %, S %, T %, in the table of FIG. 8 decrease in that order, i.e., M)S)T, since the profit of the hotel (seller) decreases as the degree of negotiation increases.

In contrast, the handling fees V % and W % to be charged to the customer (buyer) increase in that order, i.e., V(W, since the customer benefits as the degree of negotiation increases. However, if the intermediary handling fee exceeds the discount price, the customer will end up losing money. Thus, the fees V % and W % are so established that the intermediary handling fee is always lower than the discount rate.

On the other hand, the negotiation efforts by the intermediary server 1 should also be rewarded by increasing an overall charges with decrease of the negotiation price. Thus, the sum of the intermediary handling fees to the hotel (seller) and the customer (buyer) is set to be higher as the final price (reservation price) goes down. Each coefficient M, P, Q, S, T, U, V, W and X is stored in the intermediary handling fee setting unit 26 of FIG. 3. The distinction of the negotiation prices is not limited to the three types described in the foregoing, but can be two or four or more.

For the types of transaction through the negotiation described above, various other factors can also be considered in the negotiation and two or more such factors may be combined. For example, such negotiation factors may include whether a buyer is a group of customers, a long stay or short stay customer, a rush reservation request such as on the same day or a sufficiently earlier request, a stay with family, with breakfast or no breakfast, or two meals, and etc. The customer can initiate negotiation request by selecting one or more such negotiation factors on the display. Thus, the customer may be able to reach a negotiation price that is a multiple of each negotiation factor with an associated negotiation rate.

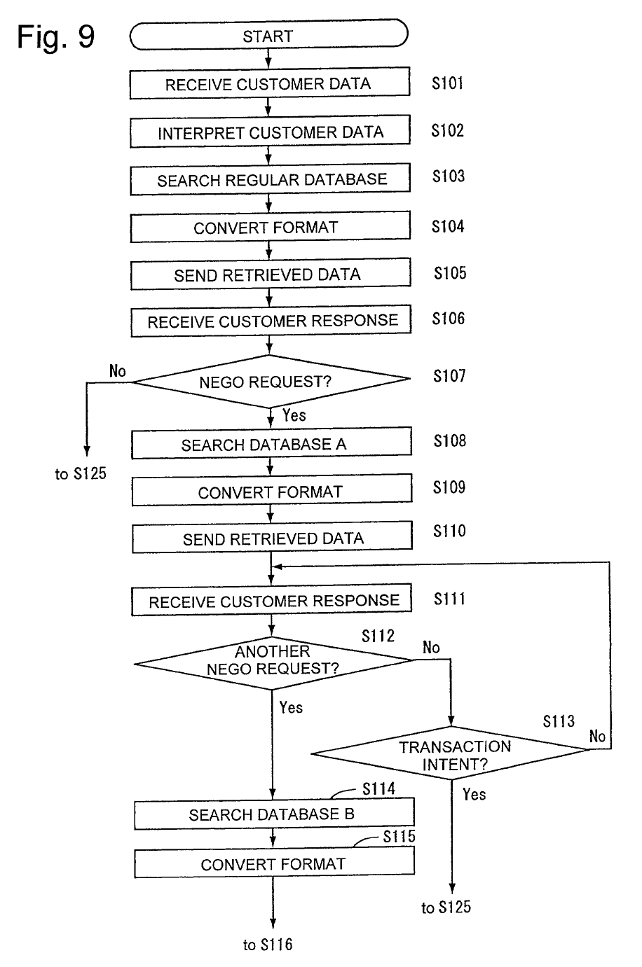

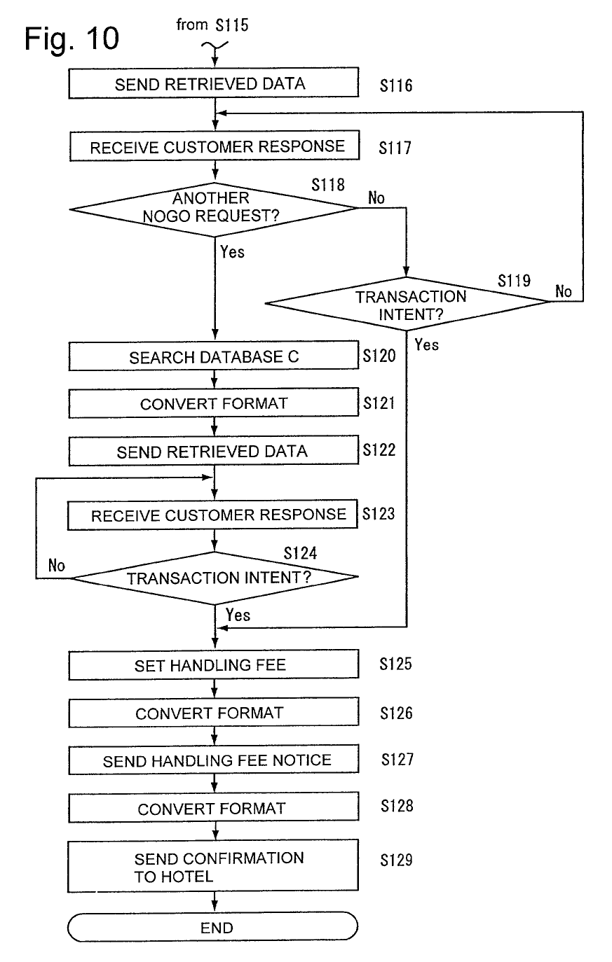

An example of transaction process including dynamic negotiation process by the intermediary server 1 of the present invention will be described in the following with reference to flow charts of FIGS. 9 and 10. Through the customer terminal 6, the customer accesses a hotel reservation site (intermediary server 1), for example, through a home page of a service provider who manages the intermediary server 1 on the Internet. The following process is described after the situation where the customer inputs data indicating his desired date, price, location of a hotel, and a type of hotel (customer purchase condition). In FIG. 9, the buyer communication section 23 in the intermediary server 1 of FIG. 3 receives the purchase condition data input by the customer in step S101. The data discriminator 24 determines that the input data is the purchase condition requested by the buyer and analyzes the contents of the input data in step S102.

The data retriever 25 searches for the information in the regular price database 28 which matches the customer purchase condition in step S103. The buy/sell condition processor 33 converts the retrieved data containing the hotel room information to a predetermined format at step S104. The format converted hotel room information is transmitted to the customer terminal 6 through the buyer communication section 23 in step S105.

Then the buyer communication section 23 receives a response from the customer in step S106. The data discriminator 24 determines whether the response from the customer is a negotiation request at step S107. If it is not a negotiation request but an intent to agree on the transaction (transaction intent), the process goes to step S125. On the other hand, if the response from the customer is a negotiation request, the data retriever 25 retrieves the hotel room information that matches the price range requested by the customer from the negotiation price database 29 (database A) at step S108. The buy/sell condition processor 33 converts the retrieved hotel room information (offer data) into a predetermined display format in step S109. The format converted offer data is sent to the customer through the buyer communication section 23 at step 110.

Then, the buyer communication section 23 receives a response from the customer in step S111. The data discriminator 24 determines whether the response from the customer is another negotiation request at step S112. If the response from the customer is not the negotiation request, the process determines whether the response is a transaction intent in step S113, and if it is, the process moves to a step S125. If it is not the transaction intent, the process goes back to step S111.

In the case where the response from the customer is another negotiation request, the data retriever 25 retrieves the hotel room information which matches the price range requested in the negotiation from the negotiation database 30 (database B) in step S114. The buy/sell condition processor 33 converts the retrieved hotel room information (offer data) into a predetermined display format in step S115. The format converted offer data is sent to the customer through the buyer communication section 23 at step 116 (FIG. 10).

Then, the buyer communication section 23 receives a response from the customer in step S117. The data discriminator 24 determines whether the response from the customer is another negotiation request at step S118. If the response from the customer is not the negotiation request, the process determines whether the response is a transaction intent in step S119, and if it is, the process moves to a step S125. If it is not the transaction intent, the process goes back to step S117.

Further in FIG. 10, in the case where the response from the customer is another negotiation request, the data retriever 25 retrieves the hotel room information which matches the price range requested in the negotiation from the negotiation database 31 (database C) in step S120. The buy/sell condition processor 33 converts the retrieved hotel room information (offer data) into a predetermined display format in step S121. The format converted offer data is sent to the customer through the buyer communication section 23 at step 122.

Then, the buyer communication section 23 receives a response from the customer in step S123. The data discriminator 24 determines whether the response from the customer is a transaction intent in step S124, and if it is, the process moves to the step S125. If it is not the transaction intent, the process goes back to step S123. If the response shows the transaction intent, the intermediary handling fee unit 26 determines server fees based on predetermined parameters including the negotiation price and seller's type in step S125. The buy/sell condition processor 33 converts the handling fees to a predetermined format in a step S126 and sends this information along with the final terms and condition of the transaction to the customer at step S127. The intermediary server 1 also converts the handling fee to the hotel into a predetermined format in step S128 and send the handling fee customer's transaction intent and the handling fee notice to the hotel at step S129, which ends the overall process.

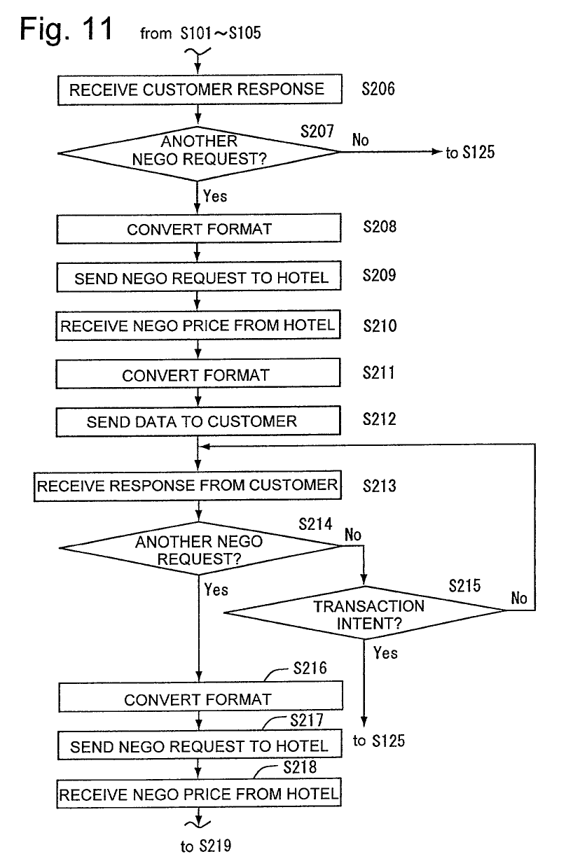

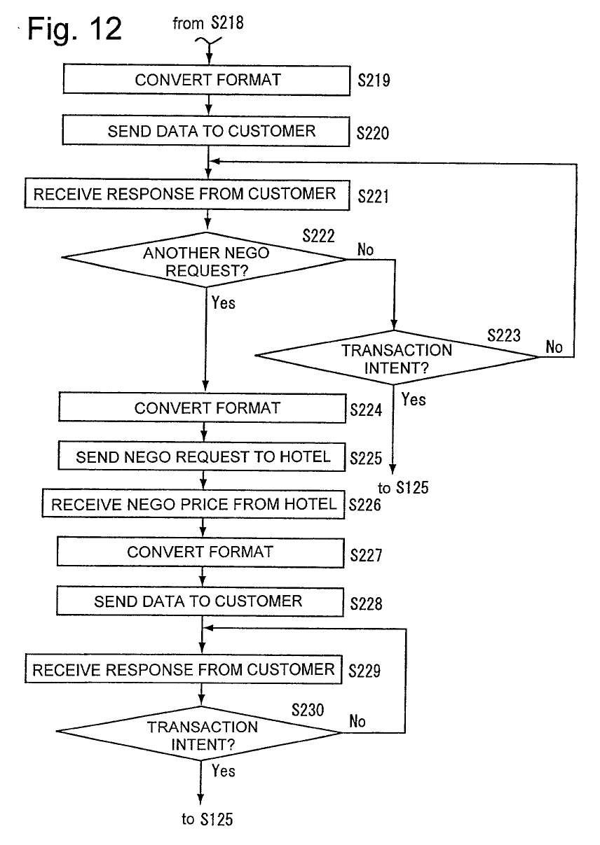

Another example of the transaction process including dynamic negotiation process by the intermediary server 1 of the present invention will be described in the following with reference to flow charts of FIGS. 11 and 12. The description will omit the process steps which are identical to those described with reference to FIGS. 9 and 10.

In FIG. 11, after the step 105 of FIG. 9, the buyer communication section 23 receives a response from the customer in step S206. The data discriminator 24 determines whether the response from the customer is a negotiation request at step S207. If it is not a negotiation request but an intent to agree on the transaction (transaction intent), the process goes to the step S125 of FIG. 10. On the other hand, if the response from the customer is a negotiation request, the buy/sell condition processor 30 converts this request to a predetermined format at step S208. The negotiation request is sent to the hotels through the seller communication section 21 at step S209.

Then, the seller communication section 21 receives the hotel room information (offer data) including the prices from the hotels in step S210. The buy/sell condition processor 33 converts the hotel room information into a predetermined display format in step S211. The format converted hotel room information is sent to the customer through the buyer communication section 23 at step 212.

Then, the buyer communication section 23 receives a response from the customer in step S213. The data discriminator 24 determines whether the response from the customer is another negotiation request at step S214. If the response from the customer is not the negotiation request, the process determines whether the response is a transaction intent in step S215, and if it is, the process moves to the step S125 of FIG. 10. If it is not the transaction intent, the process goes back to step S213.

In the case where the response from the customer is another negotiation request, the buy/sell condition processor 33 converts the negotiation request to a predetermined format at step S216, and sends the negotiation request to the hotels through the seller communication section 21 at step S217.

Then, the seller communication section 21 receives the hotel room information (offer data) including the prices from the hotels in step S218. In FIG. 12, the buy/sell condition processor 33 converts the hotel room information into a predetermined display format in step S219. The format converted hotel room information is sent to the customer through the buyer communication section 23 at step 220.

Then, the buyer communication section 23 receives a response from the customer in step S221. The data discriminator 24 determines whether the response from the customer is another negotiation request at step S222. If the response from the customer is not the negotiation request, the process determines whether the response is a transaction intent in step S223, and if it is, the process moves to the step S125 of FIG. 10. If it is not the transaction intent, the process goes back to step S221.

In the case where the response from the customer is another negotiation request, the buy/sell condition processor 33 converts the negotiation request to a predetermined format at step S224, and sends the negotiation request to the hotels through the seller communication section 21 at step S225.

Then, the seller communication section 21 receives the hotel room information (offer data) including the prices from the hotels in step S226. The buy/sell condition processor 33 converts the hotel room information into a predetermined display format in step S227. The format converted hotel room information is sent to the customer through the buyer communication section 23 at step 228.

Then, the buyer communication section 23 receives a response from the customer in step S229. The data discriminator 24 determines whether the response from the customer is a transaction intent by the customer at step S230. If the response from the customer is a transaction intent, the process moves to the step S125 of FIG. 10. If it is not the transaction intent, the process goes back to step S229. By the operational steps described above, the transaction process ends.

The operations of the intermediary server 1 are actualized in the program steps which may be embodied in a computer readable storage medium such as a CD ROM or a semiconductor memory, or a floppy disc. Such a storage medium can be separated from the intermediary server and can be installed in a separate computer. By using the storage medium storing the program for achieving the above operation steps, a computer can operate in the same manner as the intermediary server 1 described above.

The present invention is not limited to the embodiments described in the foregoing, but is capable of various modifications without departing from the spirit and scope of the present invention.

For example, in the foregoing example, the desired price range by the customer defines an upper limit and lower limit. However, it is also possible to define only an upper limit of the price range. The hotel room information with a negotiation price is displayed in a sequential order in response to the negotiation request in the above example, however, two or more different negotiation prices can be displayed on the customer terminal at the same time.

In the foregoing example, the hotel room information with negotiation prices are provided freely by the member hotels. However, the system may require that all of the member hotel must provide the hotel room information with negotiation price relative to a predetermined level of negotiation. Further, the intermediary server handling fees can be different depending on the type of seller, such as hotels, travel agents, or public organizations.

Instead of inputting the regular price with an amount of currency, it can also be specified by a ratio relative to list price (tariff price). Namely, only the tariff price is defined by the specific amount of money, and the regular price and negotiation price are defined by percentages of the tariff price, such as 30% or 50%. Thus, the negotiation price database 29 may store not the exact negotiation prices but only the percentages of the tariff prices.

The intermediary apparatus may be so arranged that the customer can renew his/her purchase condition such as a price range during the negotiation process. For example, in such an arrangement, after reviewing the offer data retrieved from the regular price database, the customer can search a hotel room with the type of hotel room in the offer data with a new price range defined by the customer. In the above example, the payment procedure of the intermediary handling fees is initiated at the same time of receiving the transaction intent by the customer, however, it can be made after the receipt of such transaction intent.

The transaction intermediary apparatus, method and system of the present invention can be applied to various transactions of goods and services other than the hotel room reservation. For example, the present invention can be applied to the transaction of plane tickets, theater tickets, home electronics appliances, automobiles, houses, furniture, pictures, souvenirs, insurance, and many others.

Although only a preferred embodiment is specifically illustrated and described herein, it will be appreciated that many modifications and variations of the present- invention are possible in light of the above teachings and within the purview of the appended claims without departing the spirit and intended scope of the invention.

What is claimed is:

1. A transaction intermediary apparatus with a negotiation capability for trading goods or services between buyers and sellers for achieving buyer driven transactions including transactions resulted from negotiation requests initiated by buyers, comprising:
a first offer data receiving means for receiving first offer data which includes regular price data of goods or services provided by at least one seller;
a second offer data receiving means for receiving at least one kind of second offer data which has conditions more beneficial to buyers in price or quality than that of the first offer data;
a requested condition data receiving means for receiving conditions requested by a buyer which includes at least a price range desired by the buyer for the goods or services;
a data retrieving means for retrieving data concerning goods or services which matches the conditions requested by the buyer;
a first offer means for offering the data on the goods or services retrieved from the first offer data by the data retrieving means to the buyer;
a negotiation request receiving means for receiving at least one negotiation request which requests a transaction condition more beneficial to the buyer in the price or quality than the data retrieved from the first offer data;
a second offer means for offering at least one kind of the second offer data to the buyer in response to the negotiation request;
a transaction intent receiving means for receiving a transaction intent of the buyer to agree on the transaction after offering the second offer data at least once; and
a transaction intent sending means for sending the transaction intent of the buyer to the seller which at least includes a seller who provides the goods or services agreed upon by the buyer.

2. A transaction intermediary apparatus as defined in claim 1, further comprising a storage means for storing at least one of the first offer data and the second offer data.

3. A transaction intermediary apparatus as defined in claim 1, wherein the subject of the transaction is hotel room reservation.

4. A transaction intermediary apparatus as defined in claim 1, further comprising a handling fee setting means for setting a handling fee to be charged to at least one of the buyer or the seller depending on a level of benefit provided to the buyer by the second offer data.

5. A transaction intermediary apparatus as defined in claim 4, wherein the handling fee setting means modifies the amount of the handling fee depending on at least one of parameters including types of the buyer and seller, goods or servers to be traded, and conditions of transaction.

6. A transaction intermediary apparatus as defined in claim 1, wherein the second offer data include data showing a degree relative to the regular price.

7. A transaction intermediary apparatus as defined in claim 1, the negotiation request by the buyer requests goods or servers more favorable to the buyer by selecting a specific price within the regular price listed in the first offer data which is within the price range initially requested by the buyer, and the second offer means provides the second offer data to the buyer in response to the negotiation request.

8. A transaction intermediary apparatus as defined in claim 1, the negotiation request by the buyer requests goods or servers more favorable to the buyer by specifying a seller and a good or service provided by the specified seller more favorable to the buyer, and the second offer means provides the second offer data to the buyer in response to the negotiation request.

9. A transaction intermediary apparatus as defined in claim 1, further comprising:
a character control means for controlling an operation of a character who negotiates with the sellers for the buyer; and
a display means for displaying the character;
wherein the character control means operates, in response to requests by the buyer, to attain the second offer data more favorable to the buyer, thereby achieving a final transaction of goods or services which matches with the negotiation request by the buyer.

10. A transaction intermediary apparatus as defined in claim 1, further comprising a payment processing means which performs a payment procedure for a transaction completed between the buyer and seller at the same time or after sending the transaction intent of the buyer to the seller.

11. A transaction intermediary apparatus for trading goods or services between buyers and sellers, comprising:
a seller input terminal for inputting first offer data which includes regular price data of goods or services and second offer data which has conditions more favorable to buyers in price or quality than that shown in the first offer data;
a buyer input terminal for inputting purchase conditions requested by a buyer which includes a price range for the goods or services; and
an intermediary server provided between the seller input terminal and the buyer input terminal for assisting the buyer who request a negotiation to attain conditions more beneficial to buyers in price or quality;
wherein, upon receiving the first offer data and the second offer data, the seller input terminal sends the first offer data and the second offer data to the intermediary server, and receives a transaction intent from the buyer;
wherein the buyer input terminal is able to input the purchase conditions by the buyer, the negotiation request, the transaction intent, and receives the first offer data and the second offer data from the sellers through the intermediary server; and
wherein the intermediary server retrieves first offer data to seek goods or services which matches the purchase conditions requested by the buyer, sends the retrieved results to the buyer, receives at least one negotiation request and retrieves the second offer data to seek goods or services which matches the negotiation request by the buyer, sends the retrieved results to the buyer, receives the transaction intent of the buyer and sends the transaction intent to the seller who provides the goods or services agreed upon by the buyer.

12. A transaction intermediary apparatus as defined in claim 11, further comprising a storage means for storing at least one of the first offer data and the second offer data.

13. A transaction intermediary apparatus as defined in claim 11, wherein the subject of the transaction is hotel room reservation.

14. A transaction intermediary apparatus as defined in claim 11, further comprising a handling fee setting means for setting a handling fee to be charged to at least one of the buyer or the seller depending on a level of benefit provided to the buyer by the second offer data.

15. A transaction intermediary apparatus as defined in claim 14, wherein the handling fee setting means modifies the amount of the handling fee depending on at least one of parameters including types of the buyer and seller, goods or servers to be traded, and conditions of transaction.

16. A transaction intermediary apparatus as defined in claim 11, wherein the second offer data include data showing a degree relative to the regular price.

17. A transaction intermediary apparatus as defined in claim 11, the negotiation request by the buyer requests goods or servers more favorable to the buyer by selecting a specific price within the regular price listed in the first offer data which is within the price range initially requested by the buyer, and the second offer means provides the second offer data to the buyer in response to the negotiation request.

18. A transaction intermediary apparatus as defined in claim 11, the negotiation request by the buyer requests goods or servers more favorable to the buyer by specifying a seller and a good or service provided by the specified seller more favorable to the buyer, and the second offer means provides the second offer data to the buyer in response to the negotiation request.

19. A transaction intermediary apparatus as defined in claim 11, further comprising:
a character control means for controlling an operation of a character who negotiates with the sellers for the buyer; and
a display means for displaying the character;
wherein the character control means operates, in response to requests by the buyer, to attain the second offer data more favorable to the buyer, thereby achieving a final transaction of goods or services which matches with the negotiation request by the buyer.

20. A transaction intermediary apparatus as defined in claim 11, further comprising a payment processing means which performs a payment procedure for a transaction completed between the buyer and seller at the same time or after sending the transaction intent of the buyer to the seller.

21. A transaction intermediary apparatus as defined in claim 11, wherein the intermediary server promotes the transaction between the buy and seller by forming an intermediary transaction system accessible through a home page on the Internet.

22. A transaction intermediary apparatus as defined in claim 11, wherein at least one of the seller input terminal or the buyer input terminal is a wireless telephone, and the intermediary server promoting the transaction between the buyer and the sellers when receiving the data through the wireless telephone.

23. A transaction intermediary method involving a negotiation capability for trading goods or services between buyers and sellers for achieving buyer driven transactions including transactions resulted from negotiation requests initiated by buyers, comprising the following steps of:
a first offer data receiving step for receiving first offer data which includes regular price data of goods or services provided by at least one seller;
a second offer data receiving step for receiving at least one kind of second offer data which has conditions more beneficial to buyers in price or quality than that of the first offer data;
a requested condition data receiving step for receiving conditions requested by a buyer which includes at least a price range desired by the buyer for the goods or services;
a data retrieving step for retrieving data concerning goods or services which matches the conditions requested by the buyer;
a first offer step for offering the data on the goods or services retrieved from the first offer data through the data retrieving step to the buyer;
a negotiation request receiving step for receiving at least one negotiation request which requests a transaction condition more beneficial to the buyer in the price or quality than the data retrieved from the first offer data;
a second offer step for offering at least one kind of the second offer data to the buyer in response to the negotiation request;
a transaction intent receiving step for receiving a transaction intent of the buyer to agree on the transaction after offering the second offer data at least once; and
a transaction intent sending step for sending the transaction intent of the buyer to the seller which includes at least a seller who provides the goods or services agreed upon by the buyer.

24. A transaction intermediary method as defined in claim 23, wherein the subject of the transaction is hotel room reservation.
